(19) United States
(12) Patent Application Publication
(10) Pub. No.: US 2024/0193701 A1
(43) Pub. Date: Jun. 13, 2024

(54) METHOD OF DISPLAYING PROFILE VIEW IN INSTANT MESSAGING SERVICE

(71) Applicant: KAKAO CORP., Jeju-Si (KR)

(72) Inventors: Sul Gi Kim, Seongnam-si (KR); Ji Hwi Park, Seongnam-si (KR); Yun Jin Kim, Seongnam-si (KR); Nam Hee Ko, Seongnam-si (KR); Hye Seon Kim, Seongnam-si (KR); Bo Young Jang, Seongnam-si (KR); Sun Je Bang, Seongnam-si (KR); Ji On Chu, Seongnam-si (KR); Seung Yong Ji, Seongnam-si (KR); Jae Ick Hwang, Seongnam-si (KR); Eun Ho Son, Seongnam-si (KR); Sang Min Seo, Seongnam-si (KR); Jeong Ryeol Choi, Seongnam-si (KR); Hye Mi Lee, Seongnam-si (KR); Shin Young Lee, Seongnam-si (KR); Seung Uk Jeong, Seongnam-si (KR)

(21) Appl. No.: 18/532,452

(22) Filed: Dec. 7, 2023

(30) Foreign Application Priority Data
Dec. 9, 2022 (KR) 10-2022-0171393
May 4, 2023 (KR) 10-2023-0058234

(51) Int. Cl. G06Q 50/00; G06Q 30/0601; H04L 51/04

(52) U.S. Cl. CPC G06Q 50/01; G06Q 30/0641; H04L 51/04

(57) ABSTRACT

A communication system retrieves profile data corresponding to a user profile of a second user, identifies a status message in the profile data, display, via a user interface of the instant messenger application, the status message; in response to receiving, via the user interface, a user input associated with the status message: query, based on the status message, a database to identify one or more items, and display, via the user interface of the instant messenger application, item data corresponding to the one or more items, receive, via the user interface, a user input associated with the one or more items, instantiate a transaction authentication of the one or more items by causing transmission of transaction information data associated with the first user, and cause, based on the transaction authentication of the one or more items, delivery of the one or more items to an account of the second user.

### CROSS-REFERENCE TO RELATED APPLICATION(S)

This application claims priority to and the benefit of Korean Patent Application No. 10-2022-0171393, filed on Dec. 9, 2022, and Korean Patent Application No. 10-2023-0058234, filed on May 4, 2023, in the Korean Intellectual Property Office, the entire disclosure of which is incorporated herein by reference for all purposes.

### BACKGROUND

With the emergence of various smart devices, including smartphones, various forms of social network service (SNS) are being utilized. In particular, instant messaging applications enabling multiple users to create chat rooms and exchange messages in real time within those chat rooms are widely used. Chat services through such instant messaging applications are evolving to provide a wide range of features tailored to satisfy various needs of users. Particularly, as the scope of services available through instant messaging applications expands, the potential for utilizing profile views to represent each user beyond simply providing a profile image is also increasing. As the potential for utilizing profile views increases, it may also be possible to provide services that enable users to interact with other users through profile views.

Moreover, as communication through smart devices increases, SNS services may not only offer one-on-one communication with other users but also integrate with various other service platforms to enable users of various item transactions.

### SUMMARY

A method and apparatus may provide an instant messaging service using one or more user interfaces associated with dynamic interrelation of user profile activity and external information via an instant messenger application. User interfaces of the executed messenger application and/or user interfaces of the chatroom interface may be improved and the communication interface associated with the dynamic interrelation of user profile activity and external information may be improved, for example, by providing profile view interfaces for one or more chatrooms.

However, technical aspects are not limited to the foregoing aspect, and there may be other technical aspects.

An apparatus configured to use an instant messenger application to automatically connect digital user activity associated with a profile view of an account with transactional item data may comprise: a display configured to receive at least one user input: a communication interface: one or more processors: and memory storing instructions that, when executed by the one or more processors, cause the apparatus to: retrieve, via the instant messenger application executing on the apparatus, profile data corresponding to a user profile of a second user, wherein the apparatus is associated with a first user; identify one or more status messages in the profile data: display, via a user interface of the instant messenger application, the one or more status messages in a user profile view of the second user; in response to receiving, via the user interface, a user input associated with the one or more status messages: query, based on the one or more status messages, a database to identify one or more transactional items; and display, via the user interface of the instant messenger application, transactional item data corresponding to the one or more transactional items; receive, via the user interface, a user input associated with the one or more transactional items: instantiate a transaction authentication of the one or more transactional items by causing transmission, to a third computing device, of transaction information data associated with the first user; and cause, based on the transaction authentication of the one or more transactional items, delivery of the one or more transactional items to an account of the second user.

The instructions, when executed by the one or more processors, may cause the apparatus to: display the transactional item data on a first portion of the user interface: simultaneously display the one or more status messages on a second portion of the user interface: query the database further based on an item identification list associated with the second user: and instantiate the transaction authentication of the one or more transactional items by receiving, via the user interface, a user input of the transaction information data.

The instructions, when executed by the one or more processors, may cause the apparatus to instantiate the transaction authentication of the one or more transactional items by: transmitting, via a chatroom associated with a service provider and using the instant messenger application, at least a portion of the transactional item data.

The instructions, when executed by the one or more processors, may cause the apparatus to display the transactional item data corresponding to the one or more transactional items by: determining, based on an item transaction restriction, whether the first user is eligible to perform a transaction operation associated with the one or more transactional items.

The user profile view may further comprise: at least one first interfacing object configured to receive the user input associated with the one or more status messages, wherein the at least one first interfacing object comprises a visual indicator indicating an interface associated with a transaction operation of the one or more transactional items; and at least one second interfacing object configured to receive a user input that causes display of an emoticon input interface associated with the one or more status messages.

An apparatus configured to use an instant messenger application server to automatically connect digital user activity associated with a profile view of an account with transactional item data may comprise: a display configured to receive at least one user input: a communication interface; one or more processors; and memory storing instructions that, when executed by the one or more processors, cause the apparatus to: transmit, to a first computing device, associated with a first user, executing an instant messenger application, profile data for a second user, wherein the profile data comprises one or more status messages received from a second computing device associated with the second user; receive, from the first computing device, a first user input associated with the one or more status messages in a user profile view of the second user: in response to the first user input: query, based on the one or more status messages, a database to identify one or more transactional items; and cause a user interface displayed by the first computing device to display transactional item data corresponding to the one or more transactional items: receive, from the first computing device, a second user input indicating a transaction authentication of the one or more transactional items; and transmit, to the second computing device, an indication of the one or more transactional items.

A method for using an instant messenger application to automatically connect digital user activity associated with a profile view of an account with transactional item data may comprise: retrieving, by a computing device, associated with a first user, executing the instant messenger application, profile data corresponding to a user profile of a second user: identifying one or more status messages in the profile data: displaying, via a user interface of the instant messenger application, the one or more status messages in a user profile view of the second user; in response to receiving, via the user interface, a user input associated with the one or more status messages: querying, based on the one or more status messages, a database (e.g., a database of a server and/or a database of a terminal, etc.) to identify one or more transactional items: and displaying, via the user interface of the instant messenger application, item transactional data corresponding to the one or more transactional items: receiving, via the user interface, a user input associated with the one or more transactional items: instantiating a transaction authentication of the one or more transactional items by causing transmission, to a third computing device (e.g., a server, an authentication device, a terminal, etc.), of transaction information data associated with the first user; and causing, based on the transaction authentication of the one or more transactional items, delivery of the one or more transactional items to an account of the second user.

The profile data may comprise one or more of: a second user interface element for interacting with the user profile of the second user, a third user interface element for displaying D-day date information, and a fourth user interface element for displaying text.

The transactional item data may be displayed on a first portion of the user interface, and the one or more status messages may be simultaneously displayed on a second portion of the user interface.

The querying the database may be further based on an item identification list associated with the second user.

The instantiating the transaction authentication of the one or more transactional items may further comprise: receiving, via the user interface, a user input of the transaction information data.

The instantiating the transaction authentication of the one or more transactional items may further comprise: transmitting, via a chatroom associated with a service provider and using the instant messenger application, at least a portion of the transactional item data.

The displaying the transactional item data corresponding to the one or more transactional items may further comprise: determining, based on an item transaction restriction, whether the first user is eligible to perform a transaction operation associated with the one or more transactional items.

The item transaction restriction may comprise at least one of: an age restriction, a country restriction, or a condition regarding an activation status of the second user.

The transactional item data may comprise transactional item stock data.

The user interface may be configured to, in response to receiving the user input associated with the one or more status messages, cause display of a visual effect associated with the profile view.

The visual effect may comprise an effect of an emoticon being displayed at predetermined coordinates on a display screen.

The method may further comprise: receiving a second user input associated with the one or more status messages: and in response to the second user input, displaying an emoticon at predetermined coordinates on a display screen.

Causing delivery of the one or more transactional items to the second user may comprise: causing display of an emoticon that indicates item transactions of the one or more transactional items.

The user profile view may further comprise: at least one first interfacing object configured to receive the user input associated with the one or more status messages, wherein the at least one first interfacing object comprises a visual indicator indicating an interface associated with a transaction operation of the one or more transactional items: and at least one second interfacing object configured to receive a user input that causes display of an emoticon input interface associated with the one or more status messages.

A method for using an instant messenger application server to automatically connect digital user activity associated with a profile view of an account with transactional item data may comprise: transmitting, to a first computing device, associated with a first user, executing an instant messenger application, profile data for a second user, wherein the profile data comprises one or more status messages received from a second computing device associated with the second user: receiving, from the first computing device, a first user input associated with the one or more status messages in a user profile view of the second user: in response to the first user input: querying, based on the one or more status messages, a database to identify one or more transactional items: and causing a user interface displayed by the first computing device to display transactional item data corresponding to the one or more transactional items; receiving, from the first computing device, a second user input indicating a transaction authentication of the one or more transactional items; and transmitting, to the second computing device, an indication of the one or more transactional items. The second computing device may be a server, a terminal, etc. The transaction authentication may comprise a purchase authentication of one or more transactional items. The transaction information data may comprise payment information associated with the first user.

The receiving the second user input may comprise: receiving, from the first computing device, transaction authentication information data.

The causing the user interface displayed by the first computing device to display the transactional item data corresponding to the one or more transactional items may comprise one or more of: causing the user interface to display information related to the one or more transactional items: causing the user interface to display a first user interface element that permits entry of item transaction message information; or causing the user interface to display a second user interface element that permits entry of transaction authentication information.

The transmitting the indication of the one or more transactional items may comprise: causing transmission, to the second computing device, of item transaction message information.

The user profile view may further comprise: at least one first interfacing object configured to receive the first user input, wherein the at least one first interfacing object comprises a visual indicator indicating an interface associated with a transaction operation of the one or more transactional items: and at least one second interfacing object configured to receive a user input that causes display of an emoticon input interface associated with the one or more status messages.

A non-transitory computer-readable storage medium storing instructions that, when executed by a processor, cause the processor to perform one or more methods described herein. Additional aspects of embodiment(s) will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a flowchart illustrating an example operating method of a terminal for transmitting product data to another account through the profile view of an account;

FIG. 2 is a flowchart illustrating an example operating method of a server for transmitting product data to another account through the profile view of an account;

FIGS. 3A, 3B, 3C, and 3D are diagrams illustrating an example process of transmitting product data;

FIG. 4 is a diagram illustrating an example screen of a terminal that receives product data;

FIGS. 5A, 5B, and 5C are diagrams illustrating an example method of transmitting an emoticon to another account through a profile view;

FIGS. 6A and 6B are diagrams illustrating an example screen displaying an emoticon receipt record or a product data receipt record; and

FIG. 7 is a block diagram of an example electronic device.

### DETAILED DESCRIPTION

The following detailed structural or functional description is provided as an example only and various alterations and modifications may be made to various features of the present disclosure. Accordingly, the examples are not to be construed as limited to the disclosure and should be understood to include all changes, equivalents, or replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

It should be noted that, if one component is described as being “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, components, or combinations thereof, but do not preclude the presence or addition of one or more other features, integers, steps, operations, elements, components or combinations thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, various examples will be described in detail with reference to the accompanying drawings. When describing the examples with reference to the accompanying drawings, like reference numerals refer to like elements and a repeated description related thereto will be omitted.

As will be detailed further below, aspects described herein improve the functioning of computers by, among other things, improving the process by which users might effectuate electronic communications and electronic purchases. Users increasingly rely on instant messenger applications for the purposes of everyday communications, birthday congratulations, life announcements, and the like. With that said, users are still forced to juggle multiple different applications and/or different web sites to engage with others in a variety of ways. For example, a user might use a social media application to announce that they were promoted, might use an instant messaging application to communicate with friends about the promotion, and might use an entirely different website to send money to those same friends to reimburse them for a meal. This juggling of different applications/websites for different use cases can be time-consuming and annoying for the average user, not to mention computationally wasteful (e.g., in terms of storage space, processor usage, and the like). Worse still, this arrangement can often make it prohibitively difficult for users to provide transactional items, such as digital content, multi-media content, electronic vouchers, products, birthday gifts, etc. For example, a user might want to send an item to their friend for their birthday, but various technical limitations (e.g., the fact that multiple applications might need to be used to learn about the birthday, pay for the gift, and send the gift, the need to identify the same friend's account on each different application) and practical limitations (e.g., the fact that the user might not know their friend's physical mailing address) might make this extremely difficult. Aspects described herein remedy these and other issues by providing an efficient way via which users might browse and purchase products for others (e.g., friends) in an instant messenger application based on status messages of those friends in that instant messenger applications. In this manner, users might have an easy, quick, and computationally straightforward way of purchasing and transmitting gifts in a single application. This approach has numerous benefits beyond mere convenience for the user: it is also safer for the purchaser and the recipient. For example, and on one hand, the purchaser need not juggle multiple accounts and applications to effectuate the purchase of the gift, lowering the user's exposure to cybersecurity threats (e.g., theft of their payment information). As another example, and on the other hand, the recipient need not disclose more personal information about themselves than necessary (e.g., such that the recipient could receive a gift without disclosing their physical mailing address or other accounts on other services).

As will also become more apparent based on the disclosure below, aspects described herein also provide a technical improvement to computing devices because aspects described herein improve the receipt and output of data using computing devices. Many computing devices, such as smartphones and tablets, have limited (and, commonly, small) output devices, such as small display screens. Moreover, input mechanisms on those devices can be limited: often, such devices lack physical keyboards or the like. As a result, it can be important to receive and output data in a manner that accounts for limitations associated with such display screens and such input modalities. The improvements described herein provide such an improvement by allowing users to avoid unnecessary application-swapping and data entry in the process of, for example, an item transaction for another user. For instance, the user interface elements described herein allow users of small touchscreen-based devices to easily purchase gifts without being forced to juggle multiple applications (e.g., an instant messaging application, a payment application, and a shopping application) while simultaneously lowering the quantity and fidelity of input needed to effectuate such purchases.

In turn, as also illustrated through the description below, aspects described herein are fundamentally rooted in instant messaging technology and the particularities of real-time communications. As such, aspects described herein could not be performed in the human mind and/or using pen and paper. For instance, the present disclosure relates to a process whereby users use particular computing elements (e.g., different computing devices executing instant messenger applications), particularly where those users engage in computer-implemented activity (e.g., instant messaging and electronic transactions of one or more items). Moreover, many of the problems addressed by the present disclosure (e.g., making it easy to buy a friend something online in response to an electronic status message) are inherent to computing devices and are not analogous to any human activity.

According to one or more aspects of the present disclosure, a server may be, for example, a server providing an instant messaging service. The server may generate an account for each of a first user and a second user and provide the first user and the second user with an instant messaging service through a messenger application installed on a terminal of the first user and a terminal of the second user. An account may include, for example, at least one type of an impersonal account (e.g., an official account, an enterprise account, a corporate account, an account of a service provider company, etc.) and a personal account. A personal account is an account intended for general individual users. An impersonal account is an account to utilize additional functions linked to an instant messaging service and may include, for example, a corporate account intended for a corporate user. The additional functions may not be available for personal accounts and may include one or more user interface elements (e.g., user interface elements associated with one or more profiles or profile views) linked to the impersonal account of the instant messaging service.

The server may correspond to a service platform that provides an instant messaging service to clients such as corporate users and individual users. A messenger application may include, for example, a computer, a database, a module, or a program operated to perform functions such as a function of composing and transmitting text, a function of transmitting multimedia content (e.g., a voice, photo, video, etc.), a message notification function, and a schedule function.

The first user (or first account) and the second user (or second account) may access the server through a respective terminal on which a messenger application is installed. The first user and the second user may be individual users having personal accounts or may be corporate users having impersonal accounts.

The terminal of the first user and the terminal of the second user may be one of electronic devices such as a computer, an ultra mobile personal computer (UMPC), a workstation, a netbook, a personal digital assistant (PDA), a portable computer, a web tablet, a wireless phone, a mobile phone, a smartphone, an e-book, a portable multimedia player (PMP), a portable game console, a navigation device, a black box, or a digital camera and may include all user devices capable of installing and executing a messenger application related to a service server 100. For example, under the control of a messenger application, a terminal may perform all operations of an instant messaging service such as service screen setting, data input, data transmission and reception, and data storage.

The messenger application may be implemented to be usable in a mobile environment as well as a personal computer (PC) environment. The messenger application may be implemented either as a standalone program or configured as an in-app feature in a predetermined application, allowing the messenger application to operate on the predetermined application.

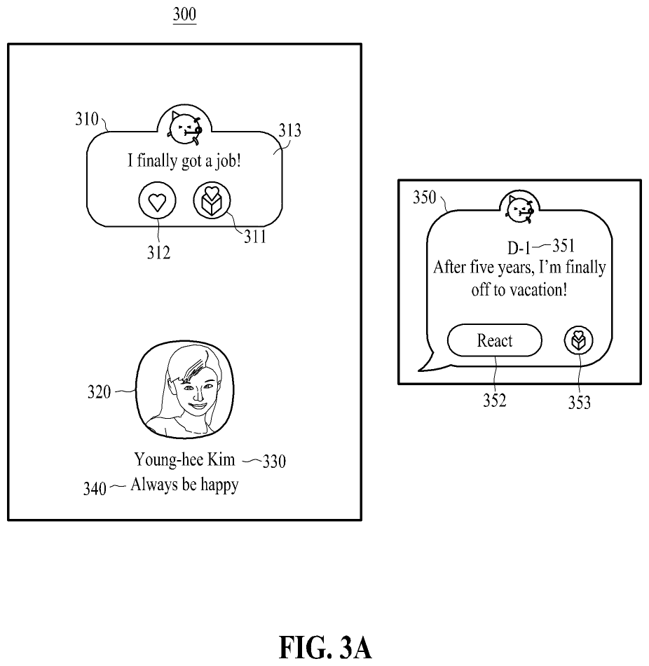

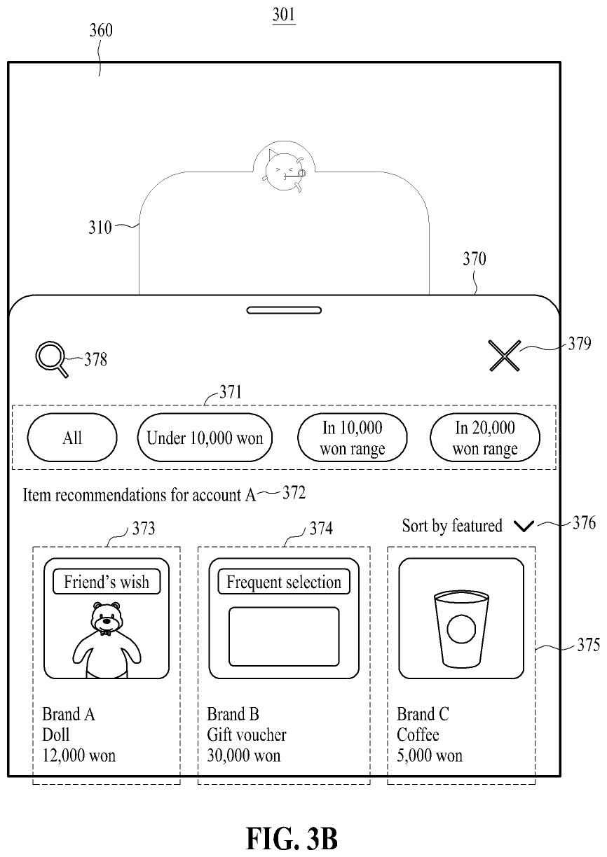

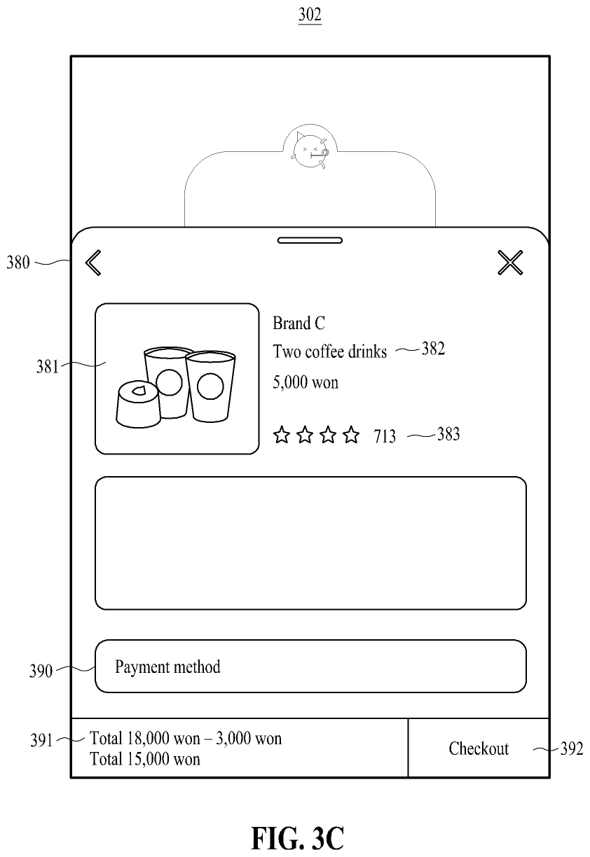

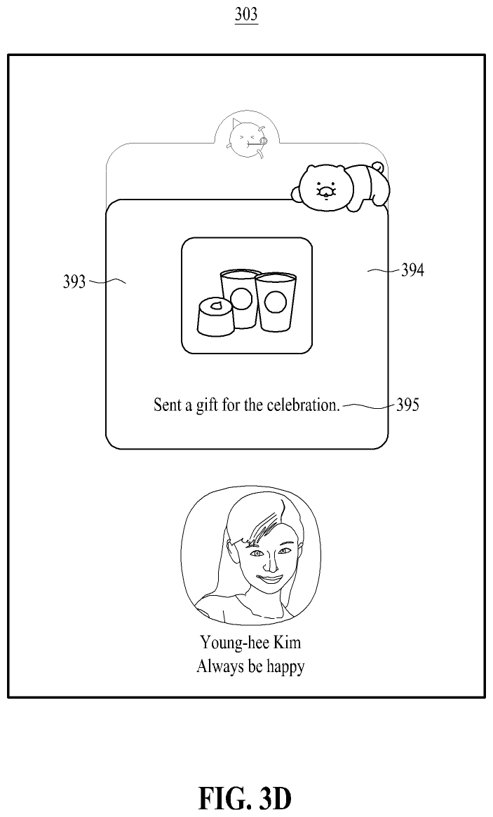

As described in detail below, an instant messaging service may provide a technique for enhancing the utilization of a profile view provided on the messenger application. The “profile view” may be a service screen representing a profile of a user and may be displayed on the screen of a terminal, as shown in a screen 300 of FIG. 3A, for example. The profile view may include, for example, a profile image, profile information, and the like provided in relation to a user account of a corresponding user. The profile view is not limited to simply including a profile image and profile information. The profile view may further include a profile background or profile items that represent a corresponding user in different ways. For example, the profile view may include a variety of pieces of information depending on the preferences of a corresponding user.

At least one profile item may be provided in the profile view. A user may apply profile item(s) to the profile view of the user (e.g., all at once). As described in detail below, the user may freely edit the profile item(s) applied to the profile view of the user through an edit view.

A plurality of profile items and/or a combination thereof may be applied to the profile view of a personal account. At least one profile item may include various types of items, such as a music item, a logo item, a sticker item, a text item, a link item, a background effect item, a D-day item, a background image item, a background video item, and a feedback item, which may be displayed through a profile view. A music item may include, for example, a playlist of audio tracks that are configured to be played through the profile view and the display style of the playlist.

The profile item may further include at least one of an item for touch input-based interaction, an item for slider input-based interaction, an item indicating the number of times another account touches the profile item, and/or an item indicating the number of views of a profile.

The profile item may further include at least one of a first item for transmitting item data (e.g., product data) to another account or a second item for interacting with another account. The second item for interacting with another account may include at least one of the item for touch input-based interaction or the item for slider input-based interaction.

The profile item may include at least one of a third item displaying D-day date information or a fourth item that is a text item displaying text. D-day may refer to a scheduled day on which a plan is to be carried out or the remaining time until the scheduled date.

The terminal may provide an edit view for editing at least one profile item applied to the profile view. The edit view may provide an edit function for applying at least one profile item described above to the profile view.

The server may be linked with an item transaction service (e.g., a gift-giving service) and/or an item transaction server (e.g., a gift-giving server). The server may provide the item transaction service linked with the instant messaging service or may provide the item transaction service by interworking with the item transaction server providing the item transaction service. The item transaction service may be a service for item transaction (e.g., purchasing a product) based on a social commerce platform, designating a receiver of the item, and delivering the item to the receiver. For example, information indicating an item transaction in the item transaction service and information indicating that an item is transmitted may be shared between a sender (e.g., the user of the first user terminal) and a receiver (e.g., the user of the second user terminal) through a chatroom provided by the instant messaging service. For example, the user may access the item transaction service through an instant messenger. The user may use the item transaction service by using the account subscribing to the instant messaging service. Alternatively or additionally, the user may use the instant messaging service by using an account subscribing to the item transaction service.

The item transaction service may provide an item identification list function (e.g., a wish list function) that allows the user to store an item the user desires to receive. The item identification list may be generated corresponding to an account signed up with the item transaction service or instant messaging service. An item identification list corresponding to a predetermined account may be shared with an account (e.g., an account registered as a friend) of another user registered under the predetermined account. In other words, a terminal logged in with the account of the user may access an item identification list corresponding to the account of another user registered as a friend. Accessing an item identification list may include accessing an item identification list interface that provides information about items included in the item identification list and provides functions (e.g., a function of adding an item to an item identification list, a function of sending an item included in an item identification list, etc.) related to the item identification list.

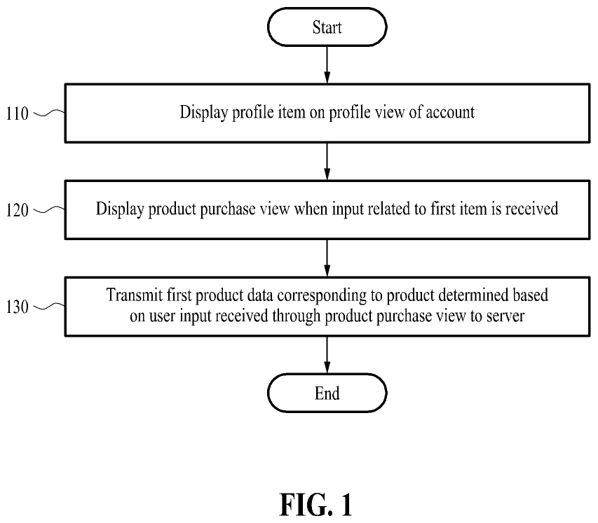

FIG. 1 is a flowchart illustrating an operating method of a terminal for transmitting product data through the profile view of an account.

The terminal may determine a profile item applied to the profile view of the account and coordinates indicating the location in the profile view at which the profile item is to be provided.

The screen of the terminal may be represented in a coordinate system (e.g., a Cartesian coordinate system using an xy coordinate system). For example, the horizontal axis of the screen may be the x-axis and the vertical axis of the screen may be the y-axis. The terminal may display various objects on the screen based on the coordinate system of the screen. The terminal may also receive a user input based on the coordinate system of the screen. If the location on the screen at which the profile item is to be displayed is selected, the terminal may convert the selected location into coordinates in the coordinate system of the screen. The terminal may transmit the coordinates to a server, allowing the server to identify the coordinates that indicate the location at which the profile item is to be provided.

The user may select the profile item applied to the profile view. In an example, after the selection of the profile item, the user may select the location in the profile view at which the profile item is to be displayed. The terminal corresponding to the account may receive, from the user, an input related to a profile item selection result and the location at which the profile item is to be displayed. The server may receive an input signal from the terminal. For example, the server may receive information related to the profile item selected by the user and the location (e.g., coordinates) in the profile view at which the profile item is to be displayed.

The server and/or terminal may receive various types of input for the profile item. For example, various types of input may include clicking, double-clicking, long-pressing, consecutive clicks, touching, double-touching, continuous touching at regular intervals, touching and holding a profile item for a predetermined time, swiping, and the like. Interaction may occur through various types of input, and aspects of the present disclosure are not limited thereto.

A second item may be an item that allows another account to react based on a touch input of the item. For example, if the second item is displayed in the profile view of an account (e.g., the second account), the second item may be displayed in the profile view of the account (e.g., the second account) on the screen of the other account (e.g., the first account). The user of the other account (e.g., the first account) may touch (or click) the second item to react to the feeling of the account (e.g., the second account). The user of the other account (e.g., the first account) may touch (or click) the second item multiple times when the level of empathy is high. Accordingly, an increased number of times the second item is touched (clicked) on may be determined as a higher level of attention from one or more users.

The second item may include an emoticon indicating a reaction of one or more users (e.g., indicating a feeling, an emotion, etc.). For example, the emoticon may be displayed together with the item indicating the number of times the second item is touched (clicked).

One or more processors (e.g., a processor 710) may perform one or more of the following operations. The processor 710 may be included in a terminal (e.g., the first user terminal or the second user terminal) and/or a server. Therefore, the operations described below may be performed in the server and/or the terminal.

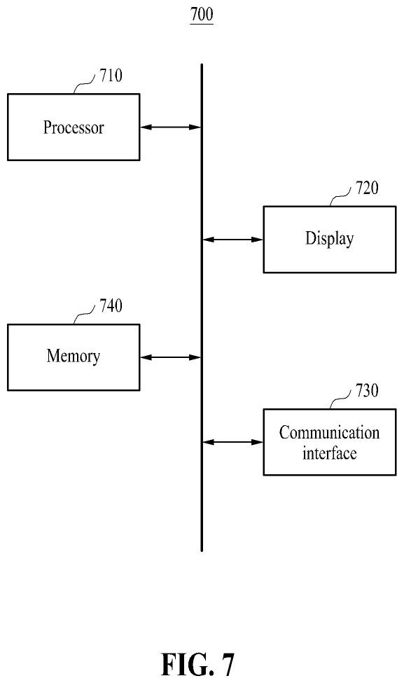

In operation 110, the processor 710 (e.g., the processor 710 of FIG. 7) of the terminal may display a profile item applied to the profile view of an account. The profile item may include a status message object registered corresponding to the account. The profile item may include at least one of a first item for transmitting product data to the account or a second item for interacting with the account. Referring to FIG. 3A, a first item 311 and a second item 312 may be displayed on a status message object 310.

The first item may be a profile item for transmitting product data to the account corresponding to the profile view. For example, the profile view of the account of a second user may be displayed on the screen of a first user terminal. The first user of the first user terminal may view the profile view of the account of the second user through the screen of the first user terminal. The first user may send an item (e.g., a product) to the second user. The first user may send an item to the second user in response to an event or a situation associated with the second user (e.g., data indicating the event and/or a condition of the second user). In this example, the first user may view the status message displayed on the profile view of the account of the second user, select the first item displayed on the profile view, and send an item to the second user. The first user may select an item to be provided to the second user through an item selection view displayed on the screen in response to the selection of the first item. If the first user selects an item for the second user, the first user terminal may generate item data related to the selected item and transmit the item data to the server. The server may transmit the item data related to the selected item to a second user terminal.

Hereinafter, for the ease of description, a terminal via which an item is identified and selected may be referred to as a first user terminal and a terminal that receives the item may be referred to as a second user terminal. However, aspects of the present disclosure are not limited thereto. In addition, as a non-limiting example, item data transmitted from the first user terminal to a server may be referred to as first item data and item data transmitted from the server to the second user terminal may be referred to as second item data. However, aspects of the present disclosure are not limited thereto.

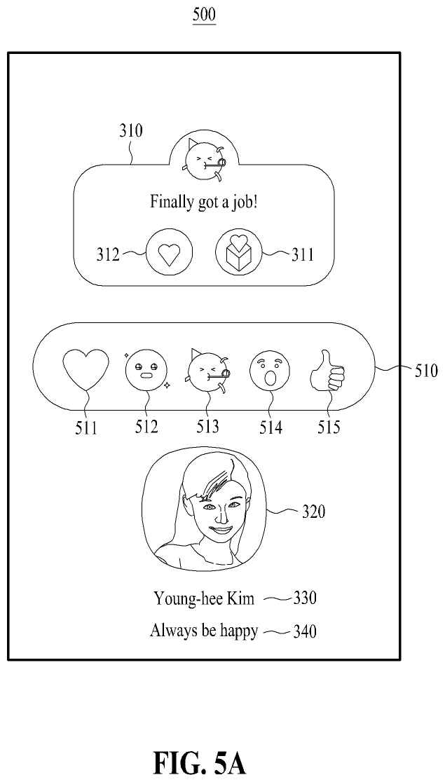

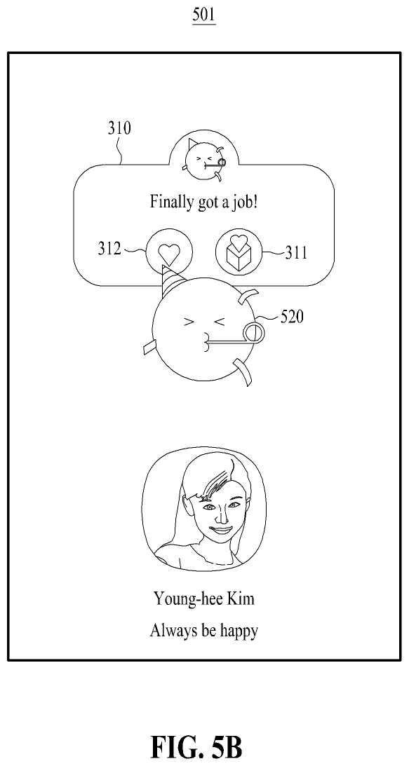

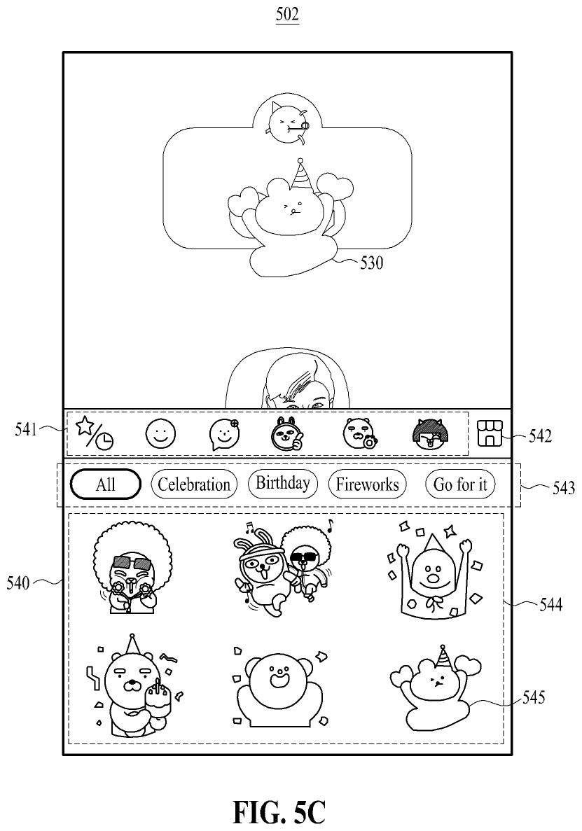

The second item may be an item for interacting with the account. The first user may respond to the event or the situation of the second user through the second item displayed on the profile view of the account of the second user. The detailed description related to the second item is provided with reference to FIGS. 5A to 5C.

The profile item may further include at least one of a third item displaying D-day date information or a fourth item displaying text. Referring to FIG. 3A, a fourth item 313 displaying text may be displayed on the status message object 310. For example, the status message “I finally got a job” may be displayed as text on the status message object 310. Referring to FIG. 3A, a third item 351 displaying D-day date information may be displayed on a status message object 350. For example, the third item 351 may be an item displaying the number of days remaining until D-day.

A profile view may be displayed on the screen 300 of FIG. 3A. At least one of the status message object 310, the first item 311, the second item 312, a profile image 320, an account name 330, and/or text 340 may be displayed with the profile view as the background. The text 340 may be a message in the text form that may be input by a user in a profile setting. In another example, the status message object 310 may include at least one of the third item 351, a second item 352, and/or a first item 353.

If an input related to a first item is received, the processor 710 of the terminal may display an item selection view on the screen. The item selection view may be a view for selecting an item (e.g., including purchasing a product). The item selection view may be a view displayed by an instant messaging application. Products (or services (hereinafter, a product may be used to include a service)) that may be sent to another account may be displayed on the item selection view. The processor 710 of the server may generate item data based on an item selected through the item selection view. Referring to FIG. 3B, a profile view 360 and the status message object 310 are displayed on a screen 301. The processor 710 of the terminal may display an item selection view 370 with the profile view 360 as the background. At least one of an item range category (e.g., a price range category 371), an item recommendation 372, sorting criteria 376, a recommended item 373 based on an item identification list, a recommended item 374 based on an item transaction record, an item 375, item search 378, or a an item selection view close button 379 may be displayed on the item selection view 370.

The item range category may be a category related to the price range of an item, a rank range of an item, or any other category range of an item. If an input with respect to a category of a predetermined item range is received, one or more items included in the range may be displayed on the screen. The item recommendation 372 category may include at least one item recommended to a predetermined account. For example, an item recommendation for account A corresponding to the terminal may be displayed on the screen. The item recommendation 372 may include a plurality of recommended item lists corresponding to various types. For example, recommended item lists based on features such as the age (e.g., 20s, 30s, etc.) and gender of a user to whom an item is to be given, and the relationship (e.g., friend, girlfriend, boyfriend, parent, etc.) with an item sender may be provided. For example, recommended item lists depending on the purpose of a transactional item (such as a digital content, a product, a wedding gift, a housewarming gift, a birthday gift, a casual gift, and a holiday gift) may be provided.

The item recommendation 372 may include a recommended item based on a status message displayed on the profile view of the account. The processor 710 of the server may determine a recommended item based on the status message. The processor 710 of the server may extract a keyword from the status message. For example, when the status message is “I finally got a job”, the keyword may be employment. The processor 710 of the server may determine a recommended item based on the keyword extracted from the status message. For example, when the status message is “I finally got a job”, the processor 710 of the server may determine a recommended item related to “employment”. In another example, when the status message is “I am on vacation for five days”, the processor 710 of the server may determine a recommended product related to “vacation”. The processor 710 of the server may analyze the category and/or meaning of the status message through natural processing (e.g., using natural language processing models, artificial intelligence models, etc.) and determine a recommended item based on the analyzed category and/or meaning. The processor 710 of the server may use a deep learning model to analyze the meaning of the status message.

The item recommendation 372 may include at least one of the recommended item 373 based on an item identification list or the recommended item 374 based on a item transaction record. An item identification list may be an item identification list of another account that is a friend's account associated with account A. For example, the recommended item 373 based on an item identification list may be an item included in the item identification list of account B that is a friend's account associated with account A. The processor 710 of the server may determine the recommended item based on the item identification list of another account. The recommended item 374 based on an item transaction record may be a recommended item based on an item transaction record corresponding to a predetermined account. An item transaction record may refer to any records related to item transactions corresponding to an account. The processor 710 of the server may determine the recommended item based on the item transaction record corresponding to the account. For example, if the number of transactions of an item by account A is more than or equal to a predetermined threshold, the processor 710 of the server may determine that the item is the recommended item 374 based on the item transaction record.

An interfacing object for the item search 378 may be an object for searching for an item to be selected for transaction. A user may search for an item to be sent through the interfacing object for the item search 378. Item search results may be displayed on the screen. The sorting criteria 376 may be an object for selecting a criterion for sorting a plurality of items displayed on the screen. For example, the sorting criteria 376 may be options including sorting by recommendation, popularity, comments, and the like. The item selection view close button 379 may be a button to close an item selection view displayed on the screen.

The item selection view may be displayed on the entire region (or a partial region) of the screen of the terminal. For example, the item selection view 370 may be displayed on the entire region of the screen 301 of FIG. 3B. In this example, the profile view may not be displayed on the screen. According to another example, an item selection view may be displayed on at least a partial region of the screen of a terminal with a profile view as the background. For example, the item selection view 370 may be displayed on at least a partial region of the screen 301 of FIG. 3B. In this example, the profile view 360 may be displayed on the screen 301 as the background and the item selection view 370 may be displayed in at least a partial region of the screen 301.

If an item is selected through the item selection view 370, the processor 710 of the terminal may display a transaction view 380 (e.g., which may include the payment view 380 of FIG. 3C) on the screen. The transaction view 380 may be a view for generating transaction information based on a user input. At least one of an item image 381, item-related information 382, item reviews 383, a transaction method (e.g., which may include a payment method 390, a payment amount 391, or a checkout button 392) may be displayed in the transaction view 380. Item-related information may be information related to an item and may include, for example, an item manufacturer, an item distributor, an expiration date of the item, the item name, a brand name associated with the item, an item value, item usage instructions, item descriptions, an order number associated with the item, a return center, an item return procedure, a barcode associated with the item, an item transaction date, customer service center information, a transaction cancellation period, usage guidelines, item return guidelines, and the like. The payment method 390 may be provided for a user to pay for a product and may include, for example, cash, cards, points, cryptocurrencies, and the like. The payment amount 391 may be an amount determined based on at least one of a product price or product discount information. The checkout button 392 may be a button for the user to confirm product purchase details and proceed with the payment. If an input of selecting the checkout button 392 is received, the processor 710 of the terminal may generate payment information.

If the transaction is completed, a transaction completion message 393 may be displayed on a screen 303 (e.g., the screen 303 of FIG. 3D) of the terminal. Referring to FIG. 3D, the transaction completion message 393 may be displayed with the profile view as the background. The transaction completion message 393 may include at least one of an item image 394, transaction completion text 395, and item-related information. The transaction completion message 393 stated above is only an example, and aspects of the present disclosure are not limited thereto.

In operation 130, the processor 710 of the terminal may transmit the first item data corresponding to an item determined based on a user input received through the item selection view to the server. For example, referring to FIG. 3B, the processor 710 of the terminal may transmit the first item data corresponding to an item 373 determined based on a user input to the server. The processor 710 of the terminal may generate transaction information corresponding to the item determined based on the user input received through the item selection view. For example, the processor 710 of the terminal may generate transaction information corresponding to the item 373 determined based on the user input. Transaction information may include information required to authorize an item transaction and may include, for example, a transaction authentication method, a payment method, payment-related authentication information, and the like. The processor 710 of the terminal may transmit the first item data including at least one of information related to an item, item transaction message information, transaction authentication information and/or payment information to the server. Item transaction message information may include information related to a message that the first user may write while providing an item to the second user. The item transaction message information may include at least one of text written by the first user, an electronic message, and/or an emoticon.

The first user terminal may transmit the first item data to the server. The second user terminal may receive the second item data corresponding to the first item data from the server. The second item data may include at least one of information related to a determined item, account information of the terminal that transmits the first item data, and/or item transaction message information. Item transaction message information received by the second user terminal may include a message generated by the first user terminal. Account information may include information related to the account corresponding to the first user terminal. For example, if the account of the first user provide an item to the account of the second user, the account information may be the account information of the first user.

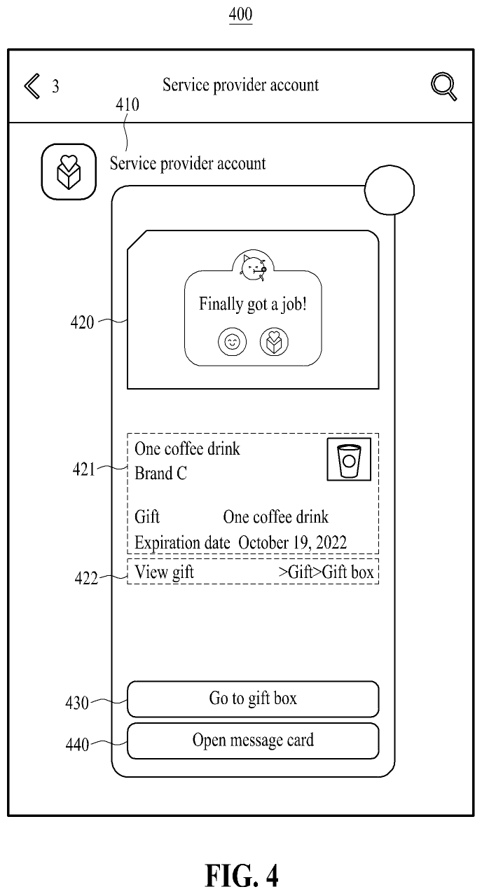

The processor 710 of the first user terminal and/or the second user terminal may display the second item data in a chatroom with a service provider account. A service provider may be an instant messaging application service provider. A service provider account may be a channel for an item transaction service. The channel may be provided in a user interface of the instant messaging application. The channel may be selected via a user input and one or more user interface elements associated with the channel may be displayed. For example, a chat room between the channel and a user account may be displayed and one or more message communications may be performed in the chat room. The user in the chat room may receive one or more messages from a service provider associated with the channel. The processor 710 of the first user terminal and/or the second user terminal may display the second item data in the form of a message through a chatroom of a channel for the item transaction service. For example, referring to a screen 400 of FIG. 4, a chatroom with a service provider account 410 may be displayed on the screen 400. The screen 400 may be displayed on the screen of the first user terminal and/or second user terminal. However, aspects of the present disclosure are not limited thereto. A message may include at least one of a status message object 420 including at least one of a first item and/or a second item, item-related information 421, instructions 422 on how to view received second item data, an item stock database access button 430 (e.g., a gift box access button), or a message information access button 440. The instructions 422 on how to view received second item data may display the instructions on how to view second product data received by the second user terminal. For example, the processor 710 of the second user terminal may display the instructions on how to view an item provided to the second user of the second user terminal. The instructions 422 on how to view received second item data may be the instructions on how to access an item stock database. The item stock database may include a list of items that are provided to a predetermined account. For example, the item stock database may include an item data list received by the account of the second user from another account. The item stock database access button 430 may be a button for accessing a list of items provided to a predetermined account. If an input of selecting the item stock database access button 430 is received, the processor 710 of the second user terminal may receive an item stock database from the server and display a list of received items on the screen. The item stock database may be an item stock database corresponding to the account of the terminal. Accordingly, the user of the terminal may view a list of items received from other users through the screen of the terminal. The processor 710 of the second user terminal may receive a record related to at least one piece of second item data stored in the item stock database corresponding to the account of the second user terminal. The processor 710 of the second user terminal may display an item data record received from another account through the first item on the screen based on the received record. The message information access button 440 may be a button for reading a message. The text included in item message information may not be displayed in the message received from the service provider account 410. Accordingly, the user may read the message received along with an item by selecting the message information access button 440.

The processor 710 of the server may determine whether an item transaction may be performed based on a predetermined condition. For example, the processor 710 of the server may restrict a minor's account from receiving or sending a predetermined type of items (e.g., an alcohol product) if certain users (e.g., minors) are not allowed to send or receive certain types of items (e.g., purchase alcohol products). Thus, when receiving an input related to the first item, the processor 710 of the server may determine whether an account corresponding to the terminal may perform an item transaction based on the item transaction restriction. For example, if an item is selected through an item selection view, the processor 710 of the server may determine whether the item transaction may be performed based on an item transaction restriction. An item transaction restriction may be a condition that restricts an item transaction through information of a predetermined account. The item transaction restriction may include at least one of an age restriction of an account corresponding to the terminal, a country restriction of the account, or a condition regarding an activation status of the account. The processor 710 of the server may place an age restriction on some items, allowing only accounts that are at or above a predetermined age to perform item transaction of those items. The processor 710 of the server may place a country restriction on some items, restricting item transactions that may be performed in a country in which an account is located. For example, there may be an item transaction that may be performed only when an account is located in a certain country (e.g., U.S.A., South Korea). In this example, if a terminal of a user is located in a country other than the certain country, the account may not be allowed for an item transaction of the item. The processor 710 of the server may restrict item transactions for a deactivated account. Accordingly, the condition regarding an activation status of the account may be a condition that indicates that only activated accounts are allowed to make item transactions.

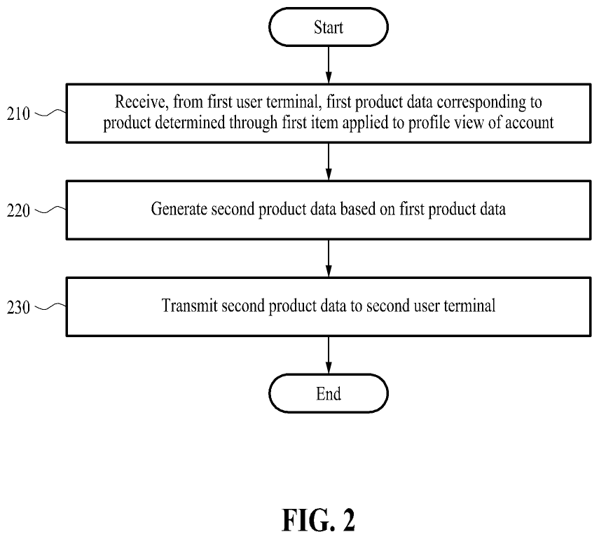

FIG. 2 is a flowchart illustrating an operating method of a server for transmitting item data to a second user terminal corresponding to an account through the profile view of an account.

In operation 210, a server may receive, from a first user terminal, first item data corresponding to an item determined through a first item applied to the profile view of the account. The first item may be a profile item for transmitting item data to the account of the second user terminal. The user of the first user terminal may select the first item displayed on the screen of the terminal. The first item may be a first item displayed on the profile view of the account of the second user terminal. The profile view of the account of the second user terminal may be displayed on the screen of the first user terminal. The first item may be displayed on the profile view of the account of the second user terminal. If the user of the first user terminal selects the first item, an item transaction view may be displayed on the screen of the terminal. The user of the first user terminal may determine the the item for transaction through the item selection view. The first user terminal may generate first item data corresponding to the item determined through the item selection view. The first user terminal may transmit first item data to the server. The first item data may include at least one of information related to the determined item, item transaction message information, and/or transaction authentication information. The server may process the authentication of an item transaction determined based on the transaction authentication information. If a transaction authentication (e.g., which may include the payment process) is not completed, the server may not generate second item data and transmit transaction failure information to the first user terminal.

In operation 220, when the transaction authentication is completed, the server may generate the second item data based on the first item data.

In operation 230, the server may transmit the second item data to the second user terminal. The second user data may include at least one of information related to the determined item, account information of the first user terminal, and/or item transaction message information. The second user terminal may receive the second item data and display the second item data in the form of a message in a chatroom with a service provider account displayed on the screen of the second user terminal.

FIGS. 3A to 3D are diagrams illustrating a process of transmitting item data.

Since the detailed description of FIGS. 3A to 3D are provided above with reference to FIG. 1, the further detailed description thereof is omitted.

FIG. 4 is a diagram illustrating the screen of a terminal that receives item data.

Since the detailed description of FIG. 4 is provided above with reference to FIG. 1, the detailed description thereof is omitted.

FIGS. 5A to 5C are diagrams illustrating a method of transmitting an emoticon to a second user terminal corresponding to an account through the profile view of the account.

For example, the profile view of the account may be displayed on the screen of a first user terminal. The account may refer to the account of a second user.

If an input related to a second item is received, the processor 710 of the first user terminal may display a visual effect corresponding to the input. The visual effect may include an effect of an emoticon being displayed at predetermined coordinates on the screen. At least one of the status message object 310, the first item 311, the second item 312, an emoticon input object 510 corresponding to a second item input, or a plurality of emoticons 511, 512, 513, 514, and 515 may be displayed on a profile view screen 500 of FIG. 5A. If an input of selecting the second item 312 is received, the processor 710 of the first user terminal may display the emoticon input object 510 on the screen. The processor 710 of the terminal may receive an input of selecting one of the plurality of emoticons 511, 512, 513, 514, and 515. If an input of selecting an emoticon is received, the processor 710 of the first user terminal may display the selected emoticon at predetermined coordinates on the screen. For example, referring to FIG. 5A, if the emoticon 513 is selected, an emoticon 520 may be displayed at predetermined coordinates on a profile view screen 501 of FIG. 5B. The processor 710 of the first user terminal may dynamically display the selected emoticon. For example, the processor 710 of the first user terminal may implement a visual effect of the selected emoticon (e.g., moving from top to bottom of the screen). In another example, the processor 710 of the first user terminal may implement a visual effect of the selected emoticon gradually increasing in size.

If an input related to the second item is received, the processor 710 of the first user terminal may display an emoticon input interface in response to the input. An emoticon input interface 540 may be displayed on a profile view screen 502 of FIG. 5C. If an input of selecting the second item 312 is received, the processor 710 of the first user terminal may display the emoticon input interface 540 on the screen. The emoticon input interface 540 may be an interface for inputting various emoticons. The emoticon input interface 540 may include at least one of an emoticon type 541, an emoticon acquisition button 542, a keyword-based emoticon category 543, or an emoticon keyboard 544. The emoticon type 541 may be a higher-level concept that includes emoticons. For example, the emoticon type 541 may be a set of emoticons defined for each emoticon character. If a user selects one of the emoticon types, various emoticons corresponding to the selected emoticon type may be displayed on the emoticon keyboard 544. If the emoticon acquisition button 542 is selected, an emoticon acquisition view may be displayed on the screen. The keyword-based emoticon category 542 may include a plurality of keywords. The processor 710 of the first user terminal may display emoticons corresponding to each keyword on the emoticon keyboard 544. The processor 710 of the first user terminal may display, at predetermined coordinates on the screen, an emoticon determined based on a user input among emoticons displayed on the emoticon input interface 540. Referring to FIG. 5C, when receiving an input of selecting an emoticon 545, the processor 710 of the first user terminal may display a selected emoticon 530 at predetermined coordinates on the screen.

The processor 710 of the first user terminal may request the server to transmit the selected emoticon to the second user terminal corresponding to the account.

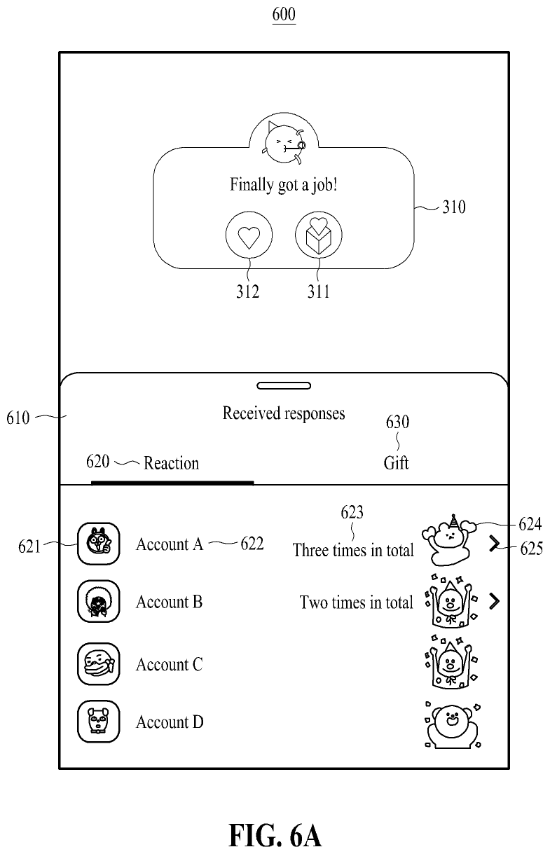

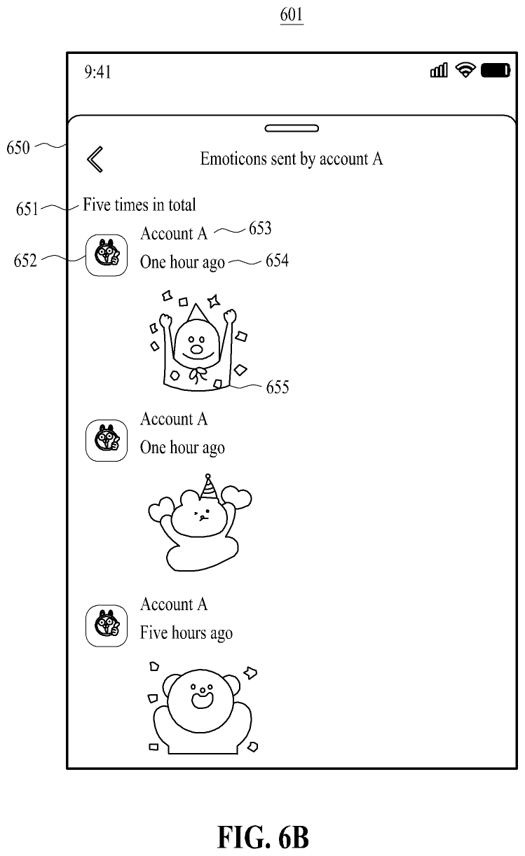

FIGS. 6A and 6B are diagrams illustrating a screen displaying an emoticon receipt record or an item data receipt record.

The processor 710 of the terminal may display an emoticon receipt record received through a second item. For example, a first user may transmit an emoticon to a second user through the second item. The second user may know through the emoticon receipt record that the first user transmits the emoticon. Referring to FIG. 6A, a reaction receipt record 610 may be displayed on a screen 600. The reaction receipt record 610 may include at least one of an item record 630 received by an account from other accounts through a first item or an emoticon receipt record 620 received by the account from other accounts through the second item. For example, a second account may add the status message object 310 in the profile view of the second account. In this example, other first accounts (e.g., account A, account B, account C, etc.) may send an emoticon to the second account through the second item 312 included in the status message object 310 displayed on the profile view of the second account. The user of the second account may view an emoticon receipt record received from other first accounts through the emoticon receipt record 620. At least one of a profile image 621 of a first account transmitting an emoticon to the second account, an account name 622, the number of times 623 an emoticon is received, a received emoticon 624, and a detailed view 625 may be displayed in the emoticon receipt record 620. The user of the first account may transmit an emoticon to the user of the second account multiple times, and the number of times the emoticon is received may be displayed on the screen of the user terminal of the second account. For example, when the user of the first account transmits an emoticon to the second account three times, “three times” may be displayed on the screen of the user terminal of the second account. An emoticon received by the second account may be displayed in the received emoticon 624. The user of the second account may identify which emoticon the first account sends as a reaction to the second account. The detailed view 625 may be an option to view an emoticon received from a predetermined account. For example, the user of the second account may receive emoticons from the user of the first account multiple times and the emoticons received multiple times may all be the same or different. The user of the second account may view the various emoticons received from the user of the first account in chronological order of receipt through the detailed view 625. Referring to FIG. 6B, a screen 601 may be a screen that is displayed when the user selects the detailed view 625. For example, when the account that transmits an emoticon to the user of the second account is account A, at least one of the number of times 651 an emoticon is transmitted by account A, a profile image 652 of account A, an account name 653, a time 654 at which an emoticon is received, or a received emoticon 655 may be displayed in a detailed view object 650.

If the item record 630 received through the first item is selected, the processor 710 of the terminal may display a record related to at least one piece of second item data stored in an item stock database on the screen. The item stock database may be an item stock database corresponding to the account of the terminal. An item record received by the user of the second account from the users of other first accounts may be displayed in the item record 630 received through the first item. The processor 710 of the terminal may display the item record received by the user of the second account from the users of other first accounts on the screen based on the record related to the second item data received from the server.

FIG. 7 is a block diagram of an electronic device.

Referring to FIG. 7, an electronic device 700 may include the processor 710, a memory 740, a communication interface 730, and a display 720. The electronic device 700 may correspond to a server and include terminals (e.g., a smartphone, a PC, a tablet PC, etc.).

The electronic device 700 may include a device related to an instant messaging service. The processor 710 may perform operations of the method described above with reference to FIGS. 1 to 6.

For example, the processor 710 may store data generated as the above-mentioned operations are performed in the memory 740 or an external database accessible from the electronic device.

The memory 740 may store the above-mentioned data and data generated as the processor 710 executes the operations. The memory 740 may be a volatile memory or a non-volatile memory.

The electronic device may be connected to an external device (e.g., a terminal or a network) through the communication interface 730 and may exchange data with the external device. For example, the electronic device may exchange data with the external device to interact with another account through the communication interface 730.

The processor 710 may display a user interface on the display 720. The screens illustrated in the above-described diagrams may be displayed on the display 720.

The processor may execute a program stored in the memory and control a device. The code of the program executed by the processor may be stored in the memory.

According to one or more aspects of the present disclosure, a terminal displays a profile item applied to a profile view of an account, wherein the profile item includes at least one of a first item for transmitting item data (e.g., product data) to the account or a second item for interacting with the account.

When an input related to the first item is received, the terminal displays a product purchase view.

The terminal transmits first product data corresponding to a product determined based on a user input received through the product purchase view to a server.

The product purchase view includes a recommended product, and the recommended product is a product determined based at least one of a status message displayed on the profile view of the account, a wish list of another account distinct from the account, or a product purchase record of the account.

The profile item further includes at least one of a third item displaying D-day date information or a fourth item displaying text.

The product purchase view is displayed on an entire region of a screen of the terminal or displayed on at least a partial region of the screen of the terminal with the profile view as a background.

The transmitting of the first product data to the server includes generating payment information corresponding to the product determined based on the user input received through the product purchase view and transmitting the first product data including at least one of information related to the product, gift message information, or payment information.

The terminal receives second product data corresponding to the first product data, wherein the second product data includes at least one of information related to the determined product, account information of a terminal that transmits the first product data, or gift message information.

The terminal displays the second product data in a chatroom with a service provider account.

When an input related to the first item is received, the terminal determines whether an account corresponding to the terminal is eligible to purchase a product based on a product purchase restriction.

The product purchase restriction includes at least one of an age restriction of an account corresponding to the terminal, a country restriction of the account, or a condition regarding an activation status of the account.

The terminal receives a record related to at least one piece of second product data stored in a product stock database.

When an input related to the second item is received, the terminal displays a visual effect corresponding to the input on a screen.

The visual effect includes an effect of an emoticon being displayed at predetermined coordinates on the screen.

When an input related to the second item is received, the terminal displays an emoticon input means in response to the input.

The terminal displays an emoticon determined based on a user input among emoticons displayed on the emoticon input means at predetermined coordinates on the screen.

The terminal displays an emoticon receipt record received through the second item.

According to an embodiment, a server transmits product data to a second user terminal corresponding to an account through a profile view of the account.

The server receives first product data corresponding to a product determined through a first item applied to the profile view of the account from a first user terminal, wherein the first item is a profile item for transmitting product data to the account.

The server generates second product data based on the first product data.

The server transmits the second product data to the second user terminal.

The server determines a product based on a user input received through a product purchase view displayed on a screen of the first user terminal in response to an input related to the first item.

The server receives the first product data corresponding to the determined product from the first user terminal.

The first product data includes at least one of information related to the determined product, gift message information, or payment information.

The second product data includes at least one of information related to the determined product, account information of the first user terminal, or gift message information.

The examples described herein may be implemented by using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The method described herein may be recorded in non-transitory computer-readable media including program instructions to implement various operations described herein. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described embodiment(s), or vice versa.

As described above, although various examples have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiment(s), and equivalents to the claims are also within the scope of the following claims.

What is claimed is:

1. An apparatus configured to use an instant messenger application to automatically connect digital user activity associated with a profile view of an account with transactional item data, the apparatus comprising:
a display configured to receive at least one user input;
a communication interface;
one or more processors; and
memory storing instructions that, when executed by the one or more processors, cause the apparatus to:
retrieve, via the instant messenger application executing on the apparatus, profile data corresponding to a user profile of a second user, wherein the apparatus is associated with a first user;
identify one or more status messages in the profile data;
display, via a user interface of the instant messenger application, the one or more status messages in a user profile view of the second user;
in response to receiving, via the user interface, a user input associated with the one or more status messages:
query, based on the one or more status messages, a database to identify one or more transactional items; and
display, via the user interface of the instant messenger application,
transactional item data corresponding to the one or more transactional items;
receive, via the user interface, a user input associated with the one or more transactional items;
instantiate a transaction authentication of the one or more transactional items by causing transmission, to a third computing device, of transaction information data associated with the first user; and
cause, based on the transaction authentication of the one or more transactional items, delivery of the one or more transactional items to an account of the second user.

2. The apparatus of claim 1, wherein the instructions, when executed by the one or more processors, cause the apparatus to:
display the transactional item data on a first portion of the user interface;
simultaneously display the one or more status messages on a second portion of the user interface;
query the database further based on an item identification list associated with the second user; and
instantiate the transaction authentication of the one or more transactional items by receiving, via the user interface, a user input of the transaction information data.

3. The apparatus of claim 1, wherein the instructions, when executed by the one or more processors, cause the apparatus to instantiate the transaction authentication of the one or more transactional items by:
transmitting, via a chatroom associated with a service provider and using the instant messenger application, at least a portion of the transactional item data.

4. The apparatus of claim 1, wherein the instructions, when executed by the one or more processors, cause the apparatus to display the transactional item data corresponding to the one or more transactional items by:
determining, based on an item transaction restriction, whether the first user is eligible to perform a transaction operation associated with the one or more transactional items.

5. The apparatus of claim 1, wherein the user profile view further comprises:
at least one first interfacing object configured to receive the user input associated with the one or more status messages, wherein the at least one first interfacing object comprises a visual indicator indicating an interface associated with a transaction operation of the one or more transactional items; and
at least one second interfacing object configured to receive a user input that causes display of an emoticon input interface associated with the one or more status messages.

6. A method for using an instant messenger application to automatically connect digital user activity associated with a profile view of an account with transactional item data, the method comprising:
retrieving, by a computing device, associated with a first user, executing the instant messenger application, profile data corresponding to a user profile of a second user;
identifying one or more status messages in the profile data;
displaying, via a user interface of the instant messenger application, the one or more status messages in a user profile view of the second user;
in response to receiving, via the user interface, a user input associated with the one or more status messages:
querying, based on the one or more status messages, a database to identify one or more transactional items; and
displaying, via the user interface of the instant messenger application, item transactional data corresponding to the one or more transactional items;
receiving, via the user interface, a user input associated with the one or more transactional items;
instantiating a transaction authentication of the one or more transactional items by causing transmission, to a third computing device, of transaction information data associated with the first user; and
causing, based on the transaction authentication of the one or more transactional items, delivery of the one or more transactional items to an account of the second user.

7. The method of claim 6, wherein the profile data comprises one or more of:
a second user interface element for interacting with the user profile of the second user,
a third user interface element for displaying D-day date information, and a fourth user interface element for displaying text.

8. The method of claim 6, wherein the transactional item data is displayed on a first portion of the user interface, and wherein the one or more status messages are simultaneously displayed on a second portion of the user interface.

9. The method of claim 6, wherein the querying the database is further based on an item identification list associated with the second user.

10. The method of claim 6, wherein the instantiating the transaction authentication of the one or more transactional items further comprises:
receiving, via the user interface, a user input of the transaction information data.

11. The method of claim 6, wherein the instantiating the transaction authentication of the one or more transactional items further comprises:
transmitting, via a chatroom associated with a service provider and using the instant messenger application, at least a portion of the transactional item data.

12. The method of claim 6, wherein the displaying the transactional item data corresponding to the one or more transactional items further comprises:
determining, based on an item transaction restriction, whether the first user is eligible to perform a transaction operation associated with the one or more transactional items.

13. The method of claim 12, wherein the item transaction restriction comprises at least one of:
an age restriction,
a country restriction, or
a condition regarding an activation status of the second user.

14. The method of claim 6, wherein the transactional item data comprises transactional item stock data.

15. The method of claim 6, wherein the user interface is configured to, in response to receiving the user input associated with the one or more status messages, cause display of a visual effect associated with the profile view.

16. The method of claim 15, wherein the visual effect comprises an effect of an emoticon being displayed at predetermined coordinates on a display screen.

17. The method of claim 6, further comprising:
receiving a second user input associated with the one or more status messages; and
in response to the second user input, displaying an emoticon at predetermined coordinates on a display screen.

18. The method of claim 6, wherein causing delivery of the one or more transactional items to the second user comprises:
causing display of an emoticon that indicates item transactions of the one or more transactional items.

19. The method of claim 6, wherein the user profile view further comprises:
at least one first interfacing object configured to receive the user input associated with the one or more status messages, wherein the at least one first interfacing object comprises a visual indicator indicating an interface associated with a transaction operation of the one or more transactional items; and
at least one second interfacing object configured to receive a user input that causes display of an emoticon input interface associated with the one or more status messages.

20. A non-transitory computer-readable storage medium storing instructions that, when executed by a processor, cause the processor to perform the method of claim 6.
